(19) United States
(12) Patent Application Publication
(10) Pub. No.: US 2008/0229633 A1
(43) Pub. Date: Sep. 25, 2008

(54) Pop-Up Type Business Card and Fabrication Method Thereof and Control System For the Same

(76) Inventor: Kwang Hyun YI, Seoul (KR)

Correspondence Address: IPLA P.A., 3580 WILSHIRE BLVD., 17TH FLOOR, LOS ANGELES, CA, 90010, US

(21) Appl. No.: 12/064,211

(22) PCT Filed: Aug. 14, 2006
(86) PCT No.: PCT/KR06/03186

§ 371 Date: Feb. 19, 2008

(30) Foreign Application Priority Data
Aug. 18, 2005 (KR) 10-2005-0075508
Aug. 8, 2006 (KR) 10-2006-0074580

(51) Int. Cl. G09F 1/00; B42D 15/02; B31F 7/00

(52) U.S. Cl. 40/124.08; 40/124.09; 283/75; 493/344; 493/356

(57) ABSTRACT

Pop-up Business Card by this invention is characterized by—information printing part which contains the information of the card such as the company name, personal name, and contact number, —main folding line generated by the line-drawing process on one side of the card so that part of the card can be folded, —cutting-line pattern which contains cutting-lines formed from the main folding-line to the other side of the card, —the 1^{st} folding-line pattern generated by line-drawing process on one side of the card so as to be juxtaposed with the cutting-line pattern, —the 2^{nd} folding-line pattern generated by line-drawing process on the other side of the card paper so as to be juxtaposed with the above cutting-line pattern, *—the generation of the solid figures on the card when it is folded according to the above main folding-line, cutting-line pattern, the 1^{st} folding-line pattern, and 2^{nd} folding-line pattern, —solid figures reversibly popped up when the card is opened from the folded state along the main folding-line above.

### TECHNICAL FIELD

This invention is related to the technology to fabricate pop-up type business card by means of design software which enables 2-dimensional and 3-dimensional designs of business card. The pop-up type business card can be made by processing folding line and cutting line which are possible by controlling the printer and cutting plotter.

### BACKGROUND ART

This invention has to do with Pop-up Business Card; More particularly, it is about the fabrication and control system of Pop-up Business Card which will give esthetic feelings with the realization of 3-dimensional solid figures.

Generally, a business card is a single sheet of about 50 mm×90 mm, on the front is printed company name, company logo, position, personal name, contact number etc.

Such general business cards are made following the course of designing by 2-dimensional design software (QuarkXPress, Photoshop, Illustrator, CorelDraw), printing, cutting, and so on.

On the other hand, recently appear business cards that contain engraved or embossed type of patterns. Generally, this type of business card is made by Thomson Work using wooden pattern, which is not appropriate to meet the characteristics of business cards-diversity, small amount of demand, etc. Considering the workability, the business card of solid design may be impossible in conventional method.

In order to realize solid design on the business card, we will need 3-dimensional solid design as well as 2-dimensional design to print the information on the card. However, without installing an automatic system to handle this complex process, it will be troublesome for the business card of solid design to be commercialized.

For pop-up business card, we may think of the Thomson Work, employed to make pop-up card for public notice. However, considering the fact that each business card carries different information along with different solid designs depending on different taste of people, a different wooden pattern has to be made at every fabrication of pop-up business card, which is quite impractical. Making solid patterns appropriate for each business card is another problem.

### DISCLOSURE OF INVENTION

### Technical Problem

This invention, taking the above-mentioned problems into consideration, is to provide the technique and control system to fabricate a business card which pops up 3-dimensional solid figures as well as 2-dimensional information when it is opened or folded.

### Technical Solution

According to the 1^{st} Working Example, the Pop-up Business Card with the purpose mentioned above is composed of the paper for business card; information printing part which contains company name, personal name, contact number; main folding-line resulting from line-drawing process so that part of the card can be folded; cutting-line pattern part which contains the cutting-line and is extended to the other side from the main folding line; the 1^{st} folding-line pattern resulting from line-drawing process on one side of the card so as to be juxtaposed with cutting-line pattern; the 2^{nd} folding-line pattern resulting from line-drawing process on the other side of the card so as to be juxtaposed with cutting-line pattern. Characteristically in this Pop-up Business Card, a certain solid figure is formed on the card when it is folded along the lines (main folding line, 1^{st} folding-line pattern, 2^{nd} folding-line pattern), and a certain solid figure pops up reversibly when the card is opened from complete folded state along the folding line.

The above cutting-line pattern includes the vertical, diagonal, or curved lines that cross the main folding line.

The 1^{st} folding-line pattern and the 2^{nd} folding-line pattern refer to the patterns, processed in strait or curved lines so as to be juxtaposed with the cutting-line pattern.

The outer side of the card can be attached by cover paper.

The cover paper can be made by folding the outstretched portion from the business card.

According to the 2^{nd} Working Example, Pop-up Business Card can be made so that a certain solid figure can pop up reversibly when the card is opened from a complete folded state along the folding line. The card also contains the printed information part containing the user's company name, personal name, contact number, etc. The card contains main folding line resulting from line-drawing process so that part of the card can be folded as well as figure-formation part along with folding-line pattern that is extended from one side of the card to the other side

Seen from another aspect, this invention tells how to fabricate Pop-up Business Card where solid figures are formed reversibly when a card is opened, which is conducted by means of the card printer and control system that controls the cutting plotter. The fabrication process contain information design phase that will be printed flat on the card; and saving phase which generates and saves the design data resulting from combining folding-line/cutting-line pattern designs that will determine a particular form on the card; printing phase in which the paper is already supplied, the design data is read, and accordingly the printer is controlled; pattern processing phase in which the paper printed with the card information is supplied to the cutting plotter, the design data of the card is read, and accordingly the above cutting plotter is controlled to process the folding-line pattern and cutting-line pattern on the card.

Seen from another aspect, this invention contains a recording media, loaded on a control system to control the card printer and cutting plotter; information design that will be printed flat on the card; saving phase which generates and saves the design data resulting from the combination of folding-line pattern design and cutting-line pattern design that will determine a particular form on the card; a printing phase in which the paper is already supplied, the design data is read, and accordingly the printer is controlled for card information to be printed on the paper; a phase in which the paper printed with the card information is supplied to the cutting plotter, the design data of the card is read, and accordingly the above plotter is controlled to process the folding-line pattern and cutting-line pattern of the card, for which a computer-readable record media, loaded with a program to perform folding-line pattern and cutting-line pattern.

In a different aspect, this invention is a control system to fabricate Pop-up Business Card in which solid figures are formed reversibly when the card is opened from a folded state. It contains interface part that will be connected to the printer and cutting plotter; information design that will be printed flat on the card; a combined processing part that generates design data in which folding-line pattern and cutting-line pattern are combined; saving part to save the design data generated by above combined process part; mechanical control part, with the paper to be processed supplied, where the design data is read and accordingly the printer is controlled to print the information on the card, and subsequently with the information-printed paper supplied to the cutting plotter, the design data is read, and the cutting plotter is controlled according to the design-data-reading to generate folding-line and cutting-line patterns.

Hereafter, I am going to present some detailed explanation for ideal practice of this invention referring the appended figures. Prior to that, I want to clarify some terms used in this invention. The terms used in this invention and filing should not be translated in customary sense or dictionary meaning. In a principle that an inventor can define the terms particularly so as to appropriately explain the invention, terms in this invention should be interpreted in harmony with the technical aspects of this invention. In addition, the working examples of this invention or composition of the drawing presented in this invention represents only the most ideal example, but it does not mean the whole possible technical aspects of this invention. Therefore, it must be cleared that, at the time of filing patent for this invention, there may be diverse other substitutes for or applications of the things presented here.

FIG. 1 is a plane figure that shows the composition of Pop-up Business Card according to the 1^{st} working example.

As shown in FIG. 1, the Pop-up Business Card made in accordance with the 1^{st} working example has the structure of information printing part (11), main folding line (12), cutting-line pattern part (hereafter just refer to the fine solid line), the 1^{st} folding-line pattern (hereafter just refer to the dual solid line) and the 2^{nd} folding-line pattern (hereafter just refer to the dual dot line), and the paper for the card (10).

The information printing part (11) is the space in which such information as company name, position, contact number, address, e-mail address, etc is printed.

The main folding-line (12) is used when folding part of the card (10) so as to form solid figures, and the line must be processed vertically from the outline of the card (10). The folding-line (12) is formed by the line-drawing process on the card (10). Here the line-drawing process can be performed by ordinary cutting plotter, which presses or scratches the surface of the card along the line so that the card (10) can be easily folded.

The cutting-line pattern is concerning the formation of the space (refer to S₁˜S₃, of Drawing 5) which exposes part of the card (10) when it is folded along the folding-line (12). The pattern, extended from the main folding-line (12) to the other side, contains the cutting-lines (13, 14) which cross the folding-line (12) vertically. Besides, it is desirable to form the pattern in diverse ways. The cutting lines (13, 14) have the function to form space (S₁) for the pop-up of the solid figure of the card.

The cutting-lines that cross the main folding-line (12) may be a diagonal line as shown in FIG. 2, or a curved line as shown in FIG. 3.

The cutting line which composes the pattern part may be plural or only one as shown in FIG. 4.

The 1^{st} folding-line pattern, formed by line-drawing process on the surface of the paper (10), must be diversified and juxtaposed with the cutting-line pattern, and the 2^{nd} folding-line pattern, formed by the line-drawing process on the other side of the paper (10), must be positioned so as to be the next to the cutting-line pattern.

The 1^{st} folding-line pattern and 2^{nd} folding-line pattern include the patterns, formed by the line-drawing process in straight or curved lines so as to be juxtaposed with the cutting-line pattern.

The folding lines of the 1^{st} folding-line pattern and those of the 2^{nd} folding-line pattern are the opposite in the folding direction, and they are opened opposite directions so as to form different figures, so to speak, a ‘valley’ and ‘mountain’ when the solid figures are popped up.

FIG. 5 shows the popped-up state of the solid figure by folding the Pop-up Card in FIG. 1. As shown in drawing, the pop-up business card, if folded about 90 from the main folding-line (12) along the 1^{st} folding-line patter and the 2^{nd} folding-line pattern, will form a particular solid figure as indicated by the cutting-line pattern, the 1^{st} folding-line pattern, and the 2^{nd} folding-line pattern.

After pop-up of the solid figures by folding, the card (10) can be kept completely folded along the main folding line (12). When the card is opened again, the card shows 3-dimensional solid figures as well as 2-dimensional information, thus adds the esthetic feelings to the business card. The solid figures return to the original state when it is folded, so it may be said that the card offers the function of reversible pop-up function.

FIG. 6 and FIG. 8 show diverse pop-up forms resulting from application of this invention. As shown in the figures, the business card may offer different esthetic feelings depending on whether the main folding-line is formed along the length or the width of the business card. Besides, the card can pop up diverse solid figures depending on the shapes of the cutting-line pattern, the 1^{st} folding-line pattern, and the 2^{nd} folding-line pattern.

For esthetic purpose, it is ideal for the outside of the Pop-up Card is topped with a cover paper. The Working Example concerning this in FIG. 9 shows Pop-up Business Card having a cover paper (20′) extended from the card (20).

As shown in the drawing, the pop-up card can be divided into four stairs. After the folding-lines (22, 24) are formed, line-drawing process is performed so that the main folding-line (22) on the card (20) can be folded inward and the cover folding-line (24) on the cover paper (20′) outward. As shown in FIG. 10, the main folding-line (22) and patterns of folding-line/cutting-line (23) can be folded to pop up solid figures, and the folding of the card along the main folding-line (22) and cover folding-line (24) can offer Pop-up Card in which card paper (20) and the cover (20) are esthetically combined.

In this case also, the information printing part (21) and folding-line/cutting-line patterns (23) can be diversified as stated above.

FIG. 11 shows a plane figure showing the structure of pop-up business card in accordance with the 2^{nd} working example.

The FIG. 11 shows that the Pop-up Business Card in accordance with the 2^{nd} working example includes the information printing part (30) and figure-formation part (33) attached to the front of the card paper (30).

The information printing part (31), as shown in the previous working example, contains the company name, personal name, position, contact number, address, e-mail, and so on.

The figure-formation part (33), as shown in the previous working example, is composed of diverse folding-line/cutting-line patterns which enable diverse pop-up figures, and is attached and supported by the attachment body (34), extended from the main folding line (32) to the other side of the card paper (30). This figure-formation part (33) should be structured so that diverse solid figures can be realized at the time of pop-up such as regular tetrahedron, cube, circular cylinder, cone, and many other applied figures.

The Pop-up Business Card of this invention realized in accordance with the 2^{nd} working example demonstrates esthetic feelings due to the 2-dimensional information and 3-dimensional solid design when solid figures pop up by the opening of the figure-formation part (33) along the patterns of the folding-line/cutting-line interlocked with the movement that the completely folded card paper (30) along the main folding line (32) opens to 90 or 180. As the figure-formation part (33) returns to the previous state with the folding of the card (30), the business card in this invention pops up solid figures reversibly. FIG. 12 shows the appearance of the Pop-up Business Card of attachment type in which the figure-formation part of pyramid type is popped up when the card paper (30) is opened.

FIG. 13 shows the functional structure of the control system that is operated in accordance with the ideal working experience of this invention and is offered for the fabrication of the pop-up business card.

According to the figure, this control system involves interface part (102), integral processing part (101), saving part (103), and mechanical control part (104).

The interface part (102) supports the mechanical connection with card printer (105) and cutting plotter (106), and ideally may employ DC communication interface such as RS 232, USB (Universal Serial Bus). Especially, as a cutting plotter (106), ordinary edge-cap-switching system or laser-cutting plotter can be used.

Integral processing part (101) functions the information design which will print flat the information of the business card as well as digital data processing function which generates the design data where the pattern-designs of folding-line and cutting-line, which determine the shape of solid figure, are combined. Here, the card information is designed by graphic software (QuarkXPress, Photoshop, Illustrator, CorelDraw, etc), and the pattern designs of folding-line and cutting-line can be designed by exclusive pop-up design software (Pop-up Card Designer, Pop-up Workshop). Integral processing part (101) generates the design data of the card by integrating the taken-in data which is designed by graphic software.

The saving part (103) is to save the design data generated by the above integral processing part, and hard disc, flash memory, etc are used for this purpose.

The mechanical control part (104) makes the information of the business card printed on the card by reading the design data from the saving part (103) and controlling the printer (105) according to the read data, in the state that the paper is supplied to the printer (105). The mechanical control part (104) conducts the processing of folding-line and cutting-line patterns by reading the design data and accordingly controlling the cutting plotter (106) in the state that the information-printed paper of the card is supplied to the cutting plotter (106).

For this invention, recording media (ram, CD Rom, Hard Disc, etc) which contain programs that will perform the 2-dimensional card information and 3-dimensional folding-line/cutting-line patterns on the paper of the card by controlling the cutting plotter and printer according to the design data of the card and integral design data generation process loaded on computer system.

FIG. 14 shows an ideal fabrication process of pop-up business card that is performed by pop-up business card fabrication system including the above-stated control system.

According to the FIG. 14, the 2-dimensional and 3-dimensional design data which are generated as the user designs the card information and patterns of folding-line/cutting-line using graphic software are sent to the integral processing part (101) of the control system (100) and accordingly the design data is generated (step S100, S110).

The above card data is saved in the saving part (103) of the control system (100) and read by the mechanical control part (104). The control part in tern (104) controls the printer (105) and prints the card information on one side of the card (step S120).

This information-printed paper is supplied to the cutting plotter (106), and the mechanical control part (104), according to the design data of the card, controls the cutting plotter (106) and performs the processing of folding-line and cutting-line formation (step S130) on one side or both sides of the card. Here the folding-line is generated by the line-drawing device of the cutting plotter (106), and the cutting-line, by the cutting device of the cutting plotter (106).

The formation of 2-dimensional information and 3-dimensional patterns of folding-line/cutting-line on the paper of the card is followed by the rim cutting (step S140), folding process (step S150) to pop up solid figures determined by the patterns of folding-line and cutting-line when the card is folded 90, and packing process (step S160) to pack the card in the state of being folded.

When fabricating the attachment type pop-up card, an additional processing is needed to attach figure-formation part within cover paper in the state of S150 above.

In addition, the pop-up card of this invention can be transformed so that the process of S160 can be performed after the process of S140. In this case, the folding can be performed by user.

As we have seen above, this invention has been explained with limited working example and figures. However, this invention is not confined to the examples here, but diverse modification and transformation are possible by the user of common knowledge in the field of this invention-related technology within the technical scope of this invention and the patent-filing scope stated below.

### ADVANTAGEOUS EFFECTS

Unlike stereo-typed conventional business cards, this pop-up business card can double the effect by providing esthetic feelings and impressive image because it shows the message or image which an individual or a company would like to emphasize in solid pop-up figures.

### BRIEF DESCRIPTION OF THE DRAWINGS

The figures attached to this specification shows an ideal working example of this invention. The figures, along with subsequent detailed explanation, are to facilitate the understanding of technical aspect of this invention. Therefore, this invention should not be understood as being limited to the specifications on the figures.

FIG. 1 is a plane figure that shows the composition of the name card, according to the 1^{st} working example of this invention.

FIGS. 2 and 4 are plane figures which show parts of diverse examples of cutting-line patterns that are formed on pop-up business card.

FIG. 5 is a perspective view which shows the pop-up of solid figures realized by folding as specified in FIG. 1.

FIG. 6 and drawing 8 are pictures of pop-up business card realized according to the transformational example of solid figures.

FIG. 9 is a plane figure of pop-up business card in the state that the cover paper can be offered.

FIG. 10 is a perspective view that popped up figure-formation part by folding the FIG. 9.

FIG. 11 is a perspective view that shows the composition of the pop-up card, realized by the 2^{nd} working example of this invention.

FIG. 12 is a picture that shows pop-up business card, realized in accordance with the transformational example of figure-formation part.

FIG. 13 is an composition chart of the control system of pop-up business card, realized an ideal working example of this invention.

FIG. 14 is a flow chart that shows the procedure of pop-up business card fabrication, realized in accordance with an ideal working example of this invention.

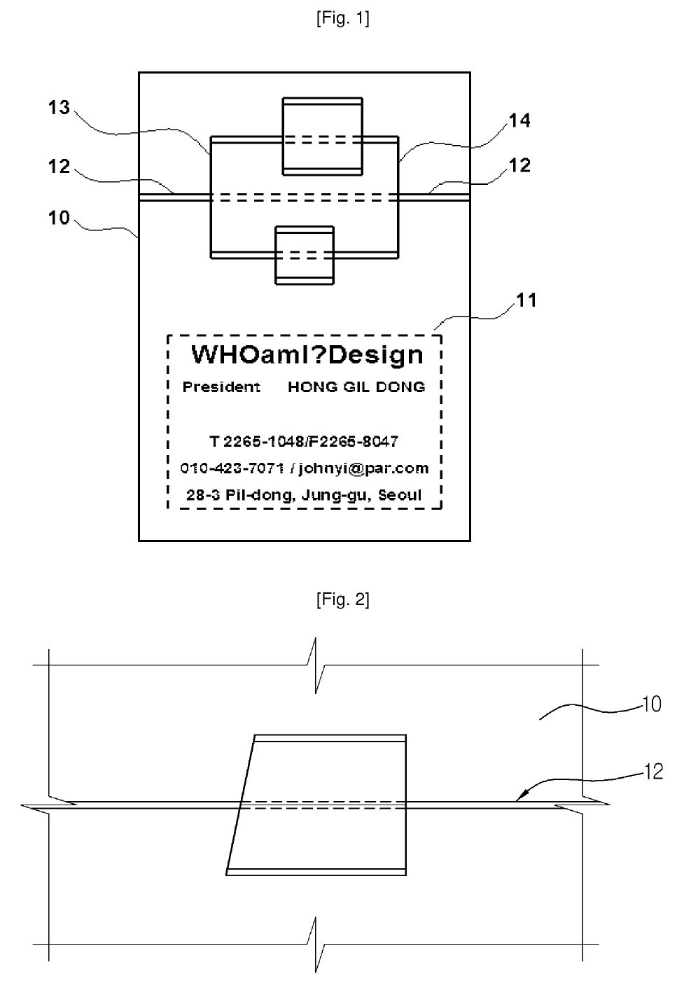

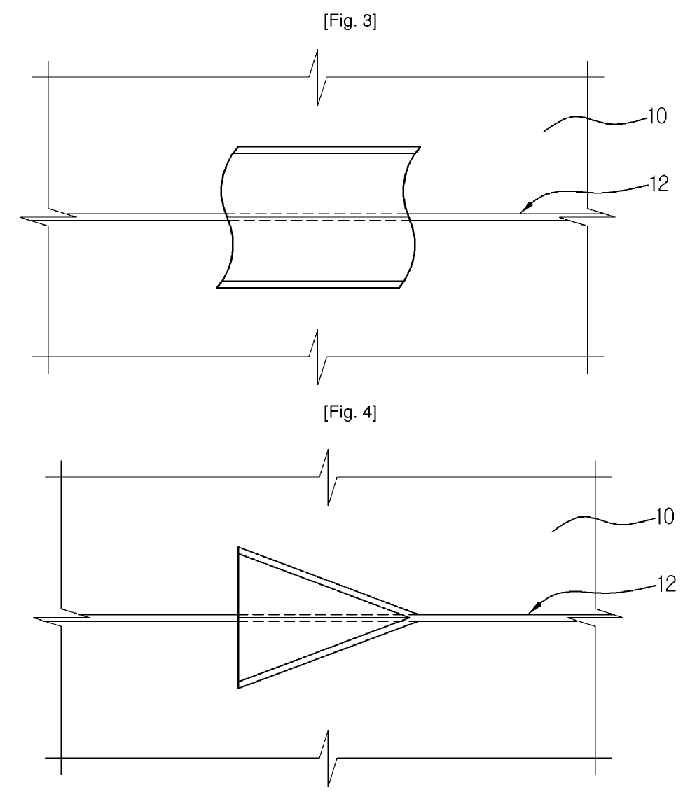

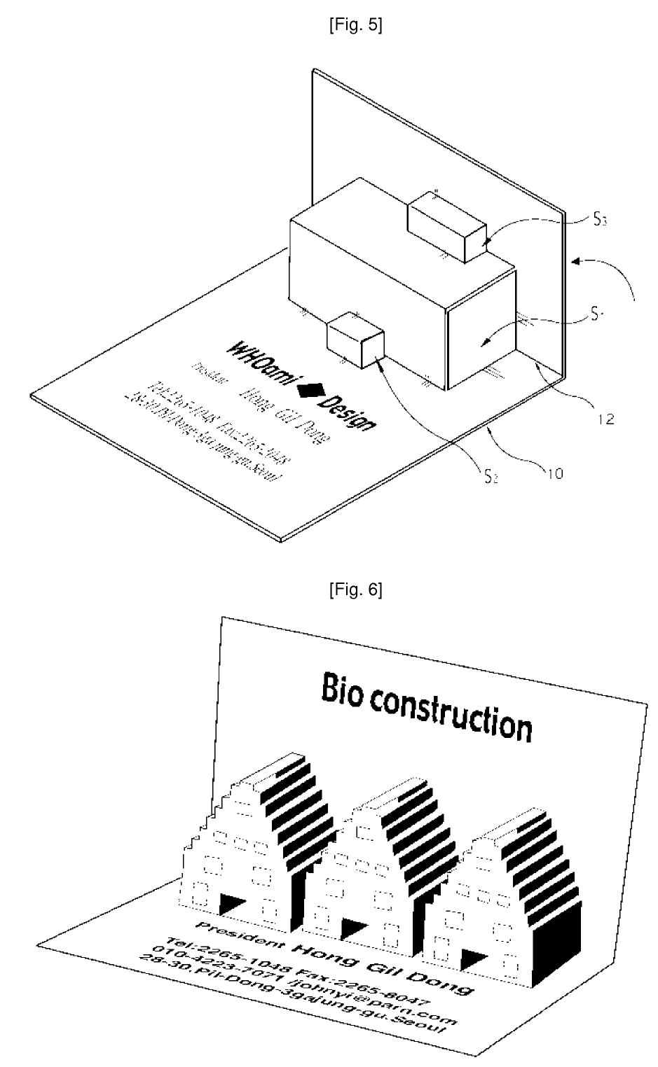

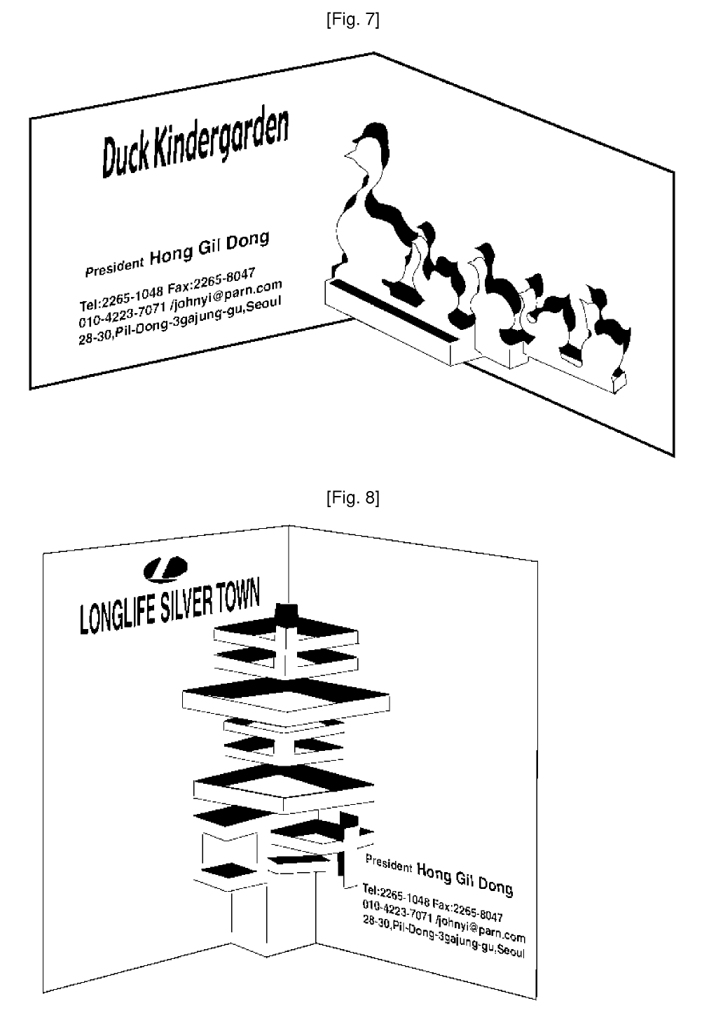

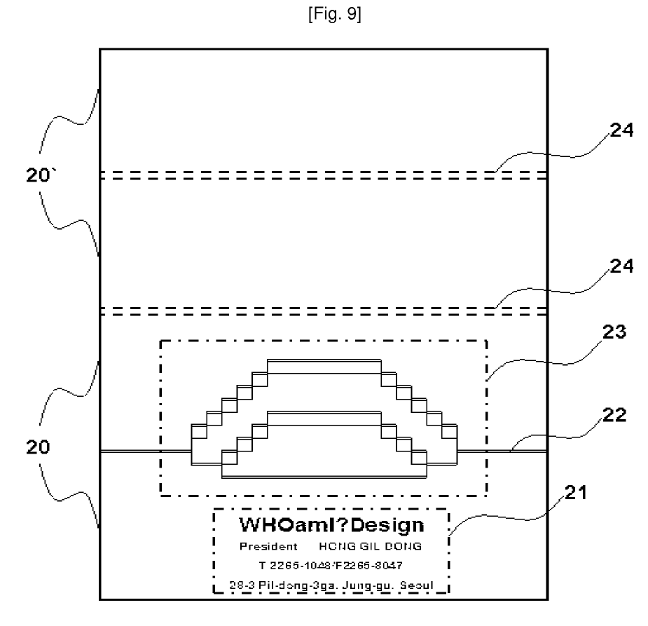

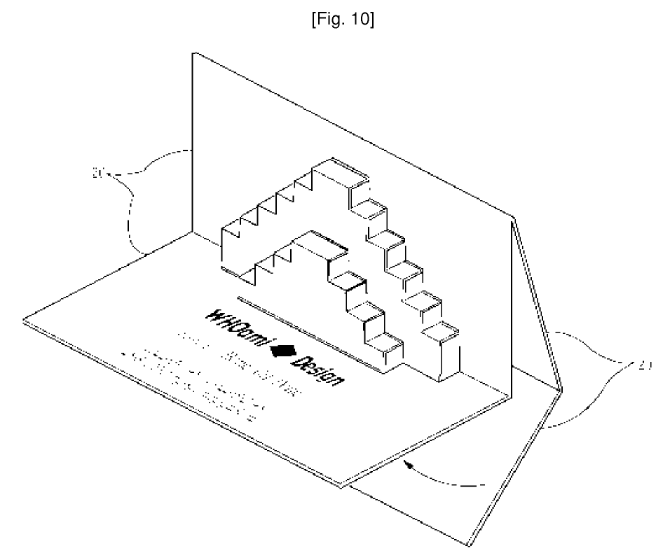

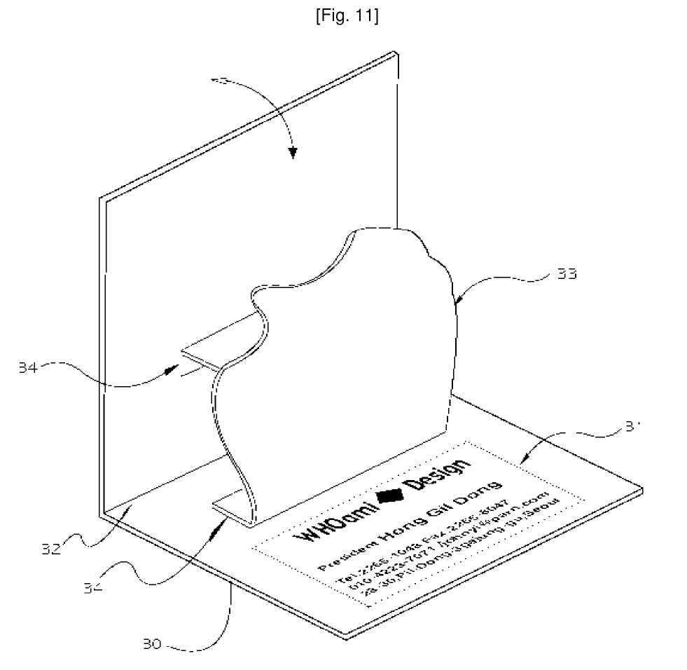

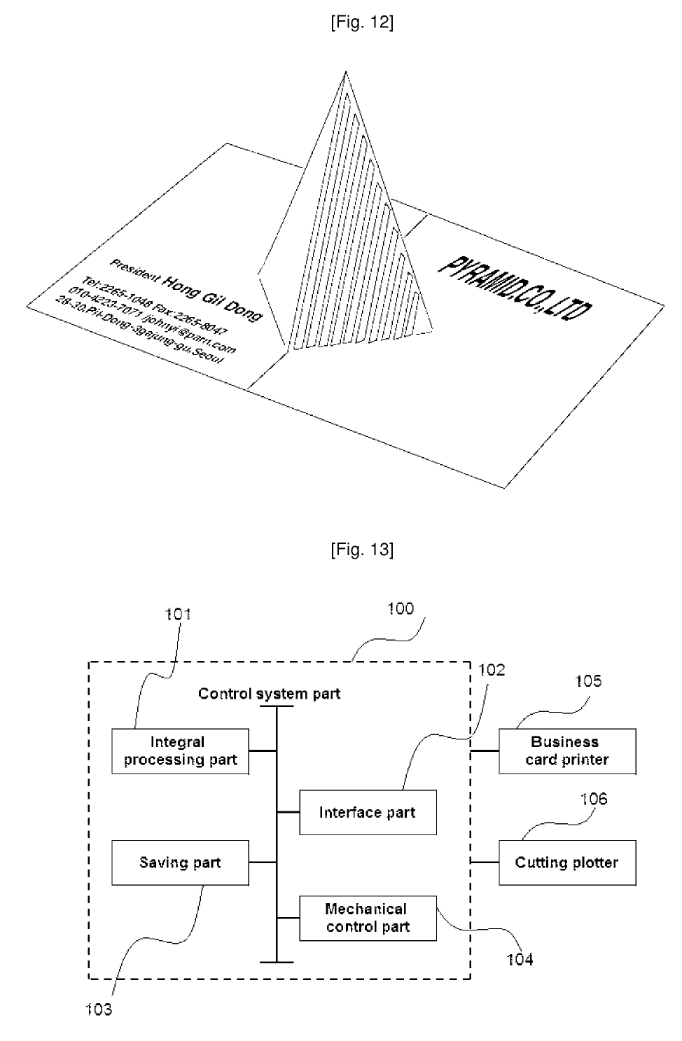

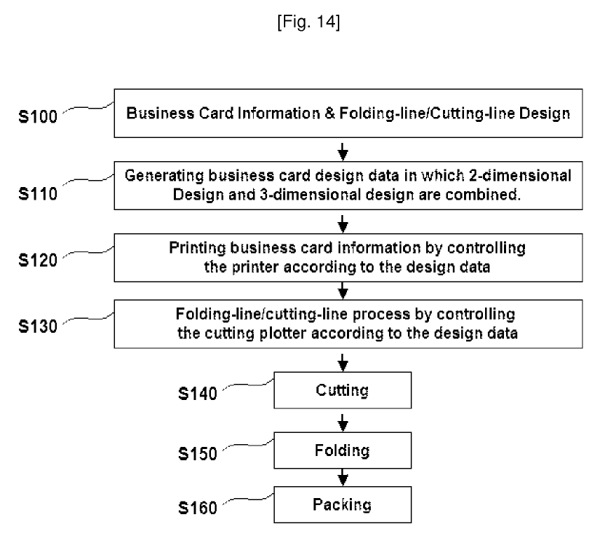

### EXPLANATION FOR SOME MAJOR REFERENCE SIGNS

10,20,30 . . . Card paper
11,21,31 . . . Information-printing
12,22,32 . . . Main folding line
20′ . . . Vover paper
33 . . . Figure-formation part
34 . . . Appendix body
100 . . . Control system
101 . . . Integral processing part
102 . . . Interface part
103 . . . Saving part
104 . . . Mechanical control part

### BEST MODE FOR CARRYING OUT THE INVENTION

The above chart shows the fabrication procedure of pop-up business card according to an ideal working example of this invention, realized in accordance with the pop-up business card fabrication system including the control system of this invention.

According to the above chart, the 2-dimensional design and 3-dimensional design data, which are generated by the design of folding-line/cutting-line pattern, are transmitted to the integral processing part (101) of the control system (100), and accordingly the design data of the card is generated (step S100 and S110)

The above design data can be saved in the saving part (103) of the control system (100), and then read by the mechanical control part (104). The mechanical control part (104) controls the printer (105) according to the design data it read and prints the information on one side of the business card (step S120).

The printed card paper is supplied to the cutting plotter (106) and the mechanical control part controls the cutting plotter (106) to form the folding-line and cutting-line on one or both sides of the card (step S130). Here, the folding-line is generated by the line-drawing device of the cutting plotter (106), and the cutting-line is generated by the cutting device of the cutting plotter (106).

After the 2-dimensional card information is printed and 3-dimensional patterns of folding-line/cutting-line, there follow the process that cuts out the edge of the card (step S140), folding process which generates the patterns of the folding-line/cutting-line by which a certain solid figure pops up with 90 folded state (step S150), and packing process (step S160) in which the card is packed with completely folded state (step S160).

In case the above-mentioned attachment type pop-up card is fabricated, there many be additional process to attach the figure-formation part that is fold at the step S150 to the inside of the cover paper.

Besides, the Pop-up Business Card of this invention can be a little modified so that the step S160 is performed right after step S140. In this case, the user of the card himself/herself can do the folding work for pop-up effect of the card.

### INDUSTRIAL APPLICABILITY

This invention is about the fabrication and control system of the Pop-up Business Card which offers esthetic feelings with 3-dimensional solid figures.

We can think of the application of already-known Thomson Work to the fabrication of business cards. But the business card has to carry different information depending on individuals and needs different solid figures to suit individually different taste. Besides, different wooden pattern has to be used at every card fabrication. Therefore it has no practicality. Moreover, it is not easy to make solid figures appropriate to the shape of the business card.

In order to form 3-dimensional solid business card, we need 2-dimensional design to print the card information and 3-dimensional solid design. According to the designs, the printing on the card and 3-dimensional fabrication process are performed.

This invention has industrial significance as it can replace the conventional 2-dimensional business cards with 3-dimensional solid business cards, equipped with automatic system making use of 2-dimensional and 3-dimensional design software and cutting plotter.

1-9. (canceled)

10. A pop-up business card, the business card comprising:
a paper for the business card:
an information printing part that contains a user's information including a company name, a personal name and a contact number;
a main folding-line formed by a line-drawing process on one side of the business card so that part of the card is folded;
a cutting-line pattern that contains cutting-lines formed and extended from the main folding line to the next side of the card;
a first folding-line pattern formed by a line-drawing process on one side of the business card to be juxtaposed with the cutting-line pattern; and
a second folding-line pattern formed by a line-drawing process on the other side of the business card to be juxtaposed with the cutting-line pattern. wherein
a solid figure determined by the first and second folding-line patterns are formed when the business card is folded along the main folding-line, the cutting-line pattern, the first folding-line pattern, and the second folding-line pattern, and the solid figure is reversibly popped up when the business card is opened from folded state along the main folding-line.

11. The pop-up business card according to claim 10, further comprising a cover paper provided on the outside of the business card.

12. The pop-up business card according to claim 11, wherein the cover paper has the same size as the business card and it is outwardly folded.

13. The pop-up business card according to claim 10, wherein the cutting-line pattern includes cutting lines having a vertical, diagonal, or curve shape that cross the main folding-line.

14. The pop-up business card according to claim 13, further comprising a cover paper provided on the outside of the business card.

15. The pop-up business card according to claim 14, wherein the cover paper has the same size as the business card and it is outwardly folded.

16. The pop-up business card according to claim 10, wherein the first and second folding-line patterns include a line-processed pattern having straight line or diagonal line so that the first and second folding-line patterns are juxtaposed with the cutting-line pattern.

17. The pop-up business card according to claim 16, further comprising a cover paper provided on the outside of the business card.

18. The pop-up business card according to claim 17, wherein the cover paper has the same size as the business card and it is outwardly folded.

19. A pop-up business card, the business card comprising:
a business card paper;
an information printing part which contains a company name, a personal name, and a contact number:
a main folding-line which is formed by a line-drawing process on one side of the business card paper so that a part of the business card is folded; and
a figure-formation part that is formed from one side to the other side of the business card and includes a folding-line pattern which generates a solid figure, wherein the solid figure is reversibly popped up when the business card is opened from the folded state along the main folding-line.

20. A method of manufacturing a business card, wherein the method is controlled by a controller that controls a printer and a cutting plotter, and a solid figure of the business card is popped up when the card is opened from its folded state, the method comprising:
a step for saving design data in which folding-line design pattern and cutting-line design pattern are combined that determine the information design that will be printed flat on the paper and the shapes of the solid figure of the card;
a step for printing card information on the paper by reading the design data and controlling the printer accordingly in the state that the paper of the card is supplied to the card printer; and
a step for generating folding-line and cutting-line patterns on the paper by controlling the cutting plotter after reading the design data when the paper of the business card on which the card information is printed is supplied to the cutting plotter.
